(19) United States
(12) Patent Application Publication
(10) Pub. No.: US 2024/0181567 A1
(43) Pub. Date: Jun. 6, 2024

(54) LASER MACHINING HEAD HAVING A HOUSING AND A WELDING NOZZLE

(71) Applicant: Fraunhofer-Gesellschaft zur Förderung der Angewandten Forschung E.V., München (DE)

(72) Inventors: Holger HILLIG, Dresden (DE); Marc KAUBISCH, Dresden (DE); Marvin LEINGRUBER, Dresden (DE)

(21) Appl. No.: 18/554,021

(22) PCT Filed: Mar. 28, 2022
(86) PCT No.: PCT/EP2022/058089

§ 371 Date: Oct. 5, 2023

(30) Foreign Application Priority Data
Apr. 7, 2021 (DE) 10 2021 203 451.9

(51) Int. Cl. B23K 26/342; B23K 26/03; B23K 37/00; B33Y 30/00

(52) U.S. Cl. CPC B23K 26/342; B23K 26/032; B23K 37/006; B33Y 30/00

(57) ABSTRACT

A laser machining head has at least one channel in a welding nozzle, through which welding filler material is deposited. At least one of the following features i) to iv) is implemented: i) a wire-shaped welding filler material is supplied through the channel into the laser beam via a drive motor. An electric current in the drive motor is measured, and the feed movement of the filler material is influenced by the measured current; ii) a strain gauge is attached to a housing or the welding nozzle, where by the strain gauge a termination of the machining process is initiated when a measurement signal value is reached; iii) a termination of the machining process is initiated by a contact arrangement on the housing; and/or iv) an electronic camera is used to monitor the supply of welding filler material, and the feed movement of at least one filler material is influenced.

The invention relates to a laser machining head with a housing and a welding nozzle, which can be used for repairing, coating and for the additive manufacturing of medium-sized and large components, e.g. for toolmaking and mold construction, power plant construction, in nuclear energy technology, turbine, machine and plant construction, ship building, in the steel industry, oil and gas industry, pipeline construction and in the agricultural industry.

Laser deposition welding is increasingly being used for coating and for additive manufacturing. However, due to its high cost and limited productivity, its applicability is limited to smaller components.

High laser powers are required to increase the deposition rate. In laser deposition welding with powdered filler materials (LPA), directionally independent processes can already be carried out at a laser power of 10 kW to 20 kW and correspondingly high deposition rates can be achieved (e.g. about 14 kg/h Inconel 625 at 20 kW). However, the high costs of powder production as well as the high costs and health hazards of handling powder are a disadvantage.

In laser deposition welding with wire-shaped filler material (LDA) so far the deposition rates have been lower or it is only possible to work in a directionally dependent manner. For welding heads that can be used in a directionally independent manner the laser power is mostly limited to 4 kW or 6 kW, as here complex and expensive optics with beam splitters (COAXwire) or ring beam optics (Precitec, COAXprinter) are used in order to be able to arrange the laser beam coaxially from several sides about the centrally fed wire to enable directionally independent operation. A further system is a machining head Fiberweld-DH of the company Lasermech, which can provide a laser power of up to 30 kW, but is very complex, large in size and has a high weight and is therefore disadvantageous for certain applications.

The COAXwireQuattroCirc LDA head uses a new concept which can be used for directionally independent operation and also for the highest laser powers. With this head a centric laser beam of low-cost standard optics is used and the filler material is supplied via multiple (2, 3 or more) wire feeders arranged coaxially about the laser beam which feed the wires laterally to the melt pool. The wire feeding devices can be combined as a wire nozzle assembly which is arranged coaxially about the laser beam, has a working distance of between 10 to 40 mm from the component/melt pool and is water-cooled. This wire nozzle is mounted directly onto the welding optics by means of an adaption, the laser beam path is closed here and a protective gas can be introduced in the upper region for protecting the optics and shielding the melt pool from atmospheric oxygen. The adjustment is carried out via an xyz adjustment unit integrated into the adaption for the coaxial alignment of the wire feed to the laser beam.

Optionally, a switch-off sensor can also be integrated into the adjustment unit, which stops the process if the wires are unintentionally welded to the component, thus preventing damage.

The same metallic wire materials can be used as filler material. However, it is also possible to use different metallic wire materials (e.g.: solid wires, cored wires) to apply a mixed welding material in situ. In addition to solid wires, cored wires can also be used.

In addition to the wire materials, powdered materials can also be supplied, e.g. in order to also be able to feed materials which cannot be produced in wire form and for example to produce a welded material in situ from two components e.g. hard material (powder) binder (wire).

Furthermore, the wire feeding device can also be equipped with exchangeable inserts which on the one hand are made from a stronger material and are thus less sensitive to wire friction and can be exchanged as a wearing part if necessary.

High-power solid-state lasers, e.g. diode lasers, fiber lasers and disk lasers with laser power greater than 200 W can be used as the laser beam source.

Optionally, a hot-wire variant is possible via resistance heating of the wires between the wire nozzle and workpiece. In this case the current flows from the machining head to the workpiece via the wires.->wire is used as an electrical resistor and is preheated.

The wires can be conveyed either by compact wire feeders mounted directly on the welding head or by a plurality of wire feeders set up externally.

Alternatively to a plurality of wire feeders, also a single wire feeder can be used which is equipped to convey a plurality of wires.

For monitoring and if necessary for controlling the wire feed, wire travel sensors can be installed in the welding head or the wire feeders mounted on the welding head.

For processing very reactive filler materials (e.g. titanium alloys) the welding head can be equipped with an external shielding gas nozzle arranged coaxially around the wire nozzle assembly.

In the known technical solutions however the safety aspect is not sufficiently considered, particularly with regard to the operating safety. Direct monitoring of the processing quality is also only possible to a limited degree.

The objective of the invention is therefore to propose options for improved operational safety and quality control during laser deposition welding.

According to the invention this objective is achieved with a laser machining head, which has the features of claim 1. Advantageous embodiments and further developments of the invention can be achieved with the features given in the dependent claims.

The housing and the welding nozzle are hollow on the inside. A laser beam is guided through both in the direction of a surface. At least in the welding nozzle at least one channel can be conveyed through the welding filler material in the direction of the surface on which welding filler material is to be applied by deposition welding into the region of influence of the laser beam. The energy of the laser beam can be used to melt supplied filler material in the region of influence of the laser beam.

At least one of the following features i) to iv) is implemented at the laser machining head:

feature i) wire-shaped welding filler material can be fed through the at least one channel by means of a wire feeder which is assigned to the respective wire-shaped welding filler material fed through a channel and which can be fed into region of influence of the laser beam by means of a drive motor. A device for determining the electric current flowing through the drive motor during the wire feed is provided on the respective drive motor for the wire feed, the measurement signals of which can be transmitted to an electronic regulation and control unit. The electronic regulation and control unit is configured to use the measured electric current to influence the feed movement of the wire-shaped welding filler material.

In feature ii) at least one strain gauge is attached to an elastically deformable region of the housing or the welding nozzle and is connected to the electronic regulation and control unit. The electronic regulation and control unit is configured here to initiate a termination of the machining process when the measurement signal of the at least one strain gauge reaches a predetermined measurement signal threshold value.

In feature iii) at least one contact arrangement is arranged and configured on the housing in such a way that the electrical contact is separated when the laser machining head impinges on or adheres to the respective surface of a workpiece or a component to be manufactured additively or other system components. A termination of the machining process is initiated by the electronic regulation and control unit (3) upon separation of the electric contact at the electric contact arrangement.

In feature iv), an electronic camera is arranged and configured in such a way that it can detect the region of the feed of welding filler material in the region of the nozzle opening of the welding nozzle. The electronic camera is connected to the electronic regulation and control unit and the electronic regulation and control unit is thereby configured to influence the feed movement of at least one wire-shaped filler material or the volumetric flow of supplied powdered welding filler material on the basis of the detected image in the region of the nozzle opening of the welding nozzle.

Here, the feature i) can only be used when wire-shaped welding filler material is supplied. The three other features can be effective when wire-shaped and powdered welding filler material used but also when feeding wire-shaped and powdered welding filler material.

Advantageously, a camera coupling can be provided in the laser machining head which camera coupling is configured to project an image of the region of the nozzle opening of the welding nozzle to the electronic camera. For this purpose, image recognition software should be integrated into the electronic regulation and control unit which is configured to recognize wire-shaped or powdered welding filler material. In this case, it should be possible to determine at least the respective position of the end face of wire-shaped welding filler material in relation to the region of influence of the laser beam, in which melting of welding filler material is possible, in the case of wire-shaped welding filler material and to use this for controlling the feed movement of this welding filler material.

In the case of powdered welding filler material it should be possible to determine the current volume of welding filler material in the region of influence of the laser beam for melting and to control the supplied volumetric flow.

In one embodiment according to feature iv) it is advantageous to arrange at least one optical filter in the beam path between the respective surface on which material is removed or welding filler material is conveyed into the region of influence of the laser beam and the electronic camera, with which optical filter an impingement of electromagnetic radiation with at least the wavelength of the laser beam on the electronic camera can be prevented. Particularly advantageously, the optical filter can be configured there or an additional optical filter can be arranged, with which an impingement of electromagnetic radiation, which is emitted as a result of the melting process of the welding filler material by means of the laser radiation, on the electronic camera can be prevented. This should be mainly NIR and IR radiation. The one or more optical filters can be edge or band-pass filters, which should be optically transparent for electromagnetic radiation at wavelengths of less than 550 nm.

An electric current source for the electric resistance heating of the respective wire-shaped filler material can be connected to the laser machining head on wire-shaped filler material. By determining the electrical resistance or the electric current flowing through the respective wire-shaped welding filler material or with a temperature sensor the temperature reached at the respective wire-shaped welding filler material can be determined and on the basis of the respectively determined temperature, a temperature control can be carried out at the respective wire-shaped welding filler material by the electronic control unit by which a sufficient preheating of the wire-shaped welding filler material can be maintained and it can be prevented that the respective wire-shaped welding filler material is heated close to its melting temperature or even that its melting temperature is reached before it has been moved into the region of influence of the laser beam.

The invention opens up the following possibilities:
Compared to the prior art the described concept is very simple, robust and cheaper to implement and only requires little adjustment.
The coaxial arrangement allows directionally independent coating, e.g. for coating complex component or for additive manufacturing. By using a plurality of filler wires (larger radiated surface) more energy is coupled into the filler material, which can increase the energy efficiency and the deposition rate. In addition, multiple reflections occur between the filler wires which further increases the absorption.
By using a plurality of filler wires, the filler material is supplied to the melt bath over a larger area and thus more uniformly, whereby the degree of mixing with the workpiece material can be minimized. In processes with a filler wire, higher melting bath temperatures and deep mixing can occur next to the wires. The position of the filler wires in the weld pool can be varied by the working distance of the wire nozzle or angles of the filler wires used to convey the filler wires into the region of influence of the laser beam.
The collision protection shutdown prevents major damage to the welding nozzle, optics and robot.
Different filler wire materials can be fed into the process at different feed rates in order to adjust the mixing ratios or create gradient layers.
Highly flexible due to the simultaneous use of wire and powdered materials which in turn can be subdivided into different materials.
Due to the inner cooling of the laser machining head it is suitable for use at extremely high power and continuous use.
Use of only “standard” optics (few optical elements) reduces costs and also enables a direct view of the weld pool by means of coaxial cameras mirrored in the laser beam for weld pool observation and control.
Suitable for laser powers from 200 W up to very high laser powers>20 kW, thereby achieving very high deposition rates.
Use of different high-powered, solid-state lasers as the laser beam source (e.g.: diode lasers, fiber lasers, disk lasers).
Slim configuration of the laser machining head enables good accessibility even for complex components.
Alternative high-performance deposition welding method to laser powder deposition welding
   Lower material costs and 100% utilization compared to LPA
   Much cleaner and safer process from a health and safety point of view (no powder handling).
Zoom optics can also be used to vary the welding track width.

In the following, the invention is explained in more detail by way of example.

In the drawings:

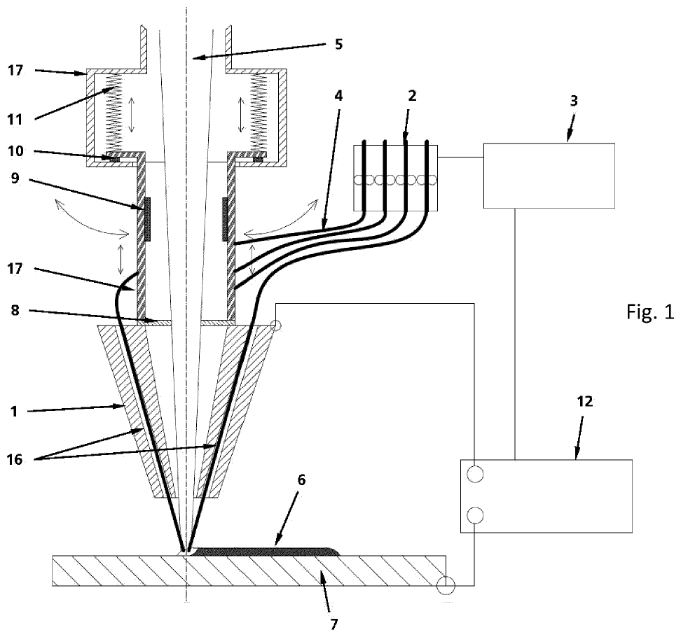

FIG. 1 shows in schematic form an example of a device for laser deposition welding;

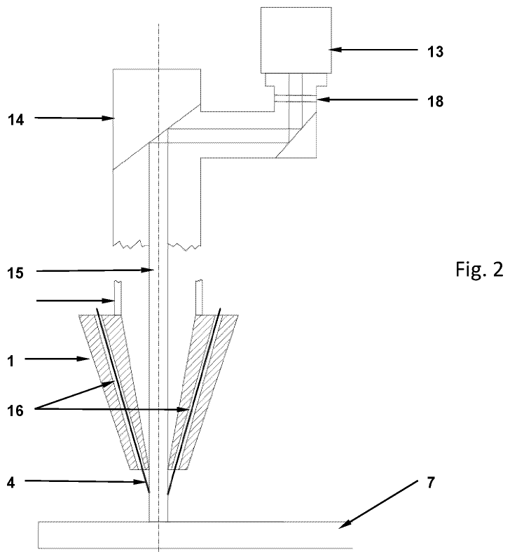

FIG. 2 shows in schematic form a further example with optical monitoring;

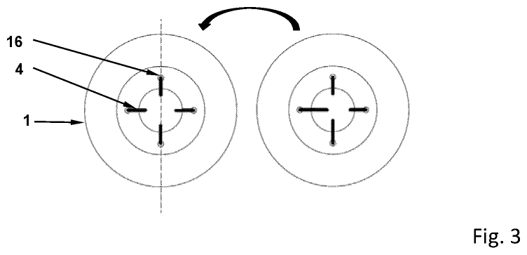

FIG. 3 shows a view of a welding nozzle with four supplied filler wires from above;

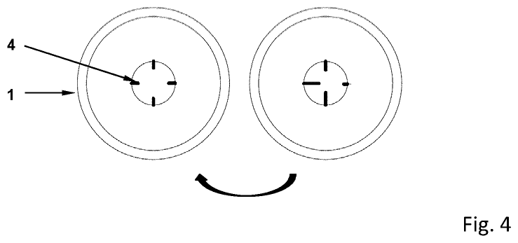

FIG. 4 shows a view of a welding nozzle with four supplied filler wires from below and

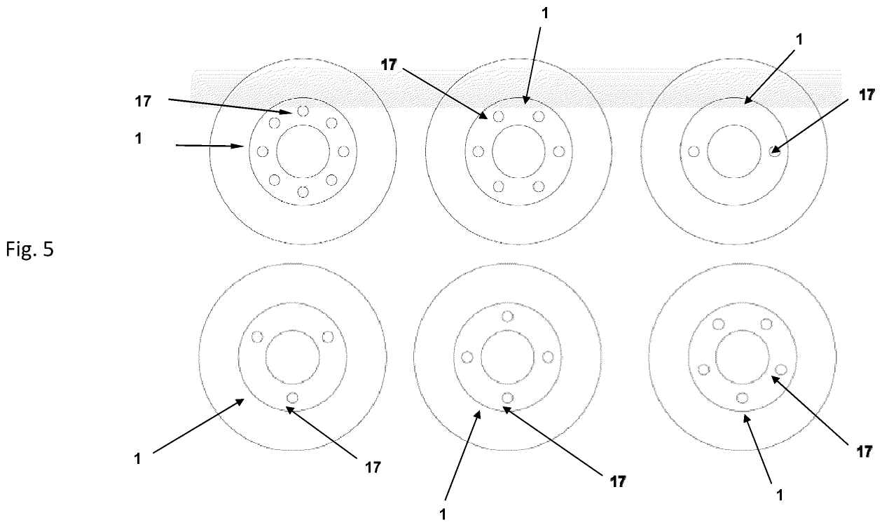

FIG. 5 shows examples of welding nozzles with a different number and arrangement of channels through which filler material can be conveyed into the region of influence of the laser beam.

By means of the wire feeders 2, which are controlled by the electronic regulation and control unit 3, wire-shaped welding filler material 4 is conveyed via the welding nozzle 1 to the surface of a workpiece 7 to be worked and melted there by means of a laser beam 5. The molten filler material 4 is used to form a deposition layer 6 on the surface.

By monitoring the individual electric currents flowing through the drive motors of the individual wire feeders 2 during the wire feed, it is possible to detect/measure by means of the electronic regulation and control unit 3 the time point and force at which the wire-shaped welding filler material 4 hits the weld pool or the workpiece 7.

In addition, on the basis of these electric currents, the wire feed speeds for individual wire-shaped welding filler materials 4 at the respective wire feeders 2 can be controlled individually and independently automatically in order to ensure uniform impingement of the wire-shaped welding filler material from the various directions with which the wire-shaped welding filler materials 4 are supplied into the region of influence of the laser beam 5 for melting the welding filler material 4. In addition, the process can be kept stable and the bonding of the coating to the surface of the workpiece can be improved.

The electric current source 12 can be used to preheat the welding filler material 4 by electric contact between the welding nozzle 1 and the workpiece 7. For this purpose, the welding nozzle 1 can be electrically insulated by an insulating element 8 so that the electric current of the current source 12 can flow via the wire-shaped welding filler material 4 only from the welding nozzle 1 to the workpiece 7. The wire-shaped welding filler material 4 is used as an electric resistor and heats up due to the electric current supply and the direction of flow of the electric current from the welding nozzle 1 to the workpiece 7. By determining the temperature of the wire-shaped welding filler material 4, not shown, before it enters the region of influence of the laser beam 5, a temperature control can be achieved by which sufficient preheating can be achieved and premature undesired melting can be prevented.

By means of a plurality of wire feeders 2 different metallurgical compositions can be obtained for a coating on the workpiece surface of wire-shaped welding filler materials 4. Thus different alloys, alloy compositions and also gradient layers can be formed in which the material composition changes continuously or successively.

A collision of the laser machining head can be detected via strain gauges 9 and a process stop can be initiated. At least one strain gauge 9, in the example shown there are two, can be attached to an elastically deformable region of the housing 16, which can deform elastically when the laser machining head is struck. This can be used with a corresponding measurement signal detected with a strain gauge 9 which is supplied to the electronic regulation and control unit 3 to abruptly end or interrupt the process.

The welding nozzle 1 can additionally detect collisions and initiate a process stop via tensioning springs 11 which compress when force is applied. Smaller collisions can thus be compensated in X, Y and Z directions. Here an electric contact arrangement 10 can be used, pressed onto one another by the tensioning springs 11 during normal operation. An electric current flows via the electric contact arrangement 10 during normal operation. In the event of a collision tensioning springs 11 are compressed and the electric contact at the contact arrangement 10 is thus lost and a process stop can be initiated. The travel compensation in X, Y and Z direction can be compensated by the tensioning springs 11 up to the process stop.

FIG. 2 shows how the wire-shaped welding filler material 4 can be observed by an electronic camera 13 and positioned. The electronic camera 13 records the actual position of the wire-shaped welding filler material 4 before welding begins via the reflection radiation 15 and a camera coupling 14 and can adjust this from an uneven stickout, see FIG. 3 on the right, to an even stickout, see FIG. 3 on the left, by corresponding control of the respective wire feeder 2 such that the end faces of the wire-shaped filler material 4, which are supplied from different directions, can be arranged or aligned at equal or predetermined distances from one another. If the end faces are equidistant from one another a homogeneous coating can be formed which applies in particular to the material composition of the deposited coating 6. By selectively adjusting the spacing of the end faces of the wire-shaped filler material, which is supplied from different directions, it is possible to influence the respective width of the formed coating track and/or in the case of wire-shaped filler materials 4 fed differently into the region of influence of the laser beam 5 it is possible to influence the alloy composition in the coating 6 by appropriately controlling the drive motors of the respective wire feeders 2.

FIG. 3 shows a welding nozzle 1 from below and FIG. 4 shows the welding nozzle 1 from above. In each case, four wires of welding filler material 4 are supplied at angular intervals of 90°. In this case the images on the left show states in which the four wire-shaped welding filler materials 4 are equally spaced from each other with their end faces facing each other so that uniform melting can be achieved when the optical axis of the laser beam 5 is positioned centrally on the four wire-shaped welding filler materials 4. In the images on the right in FIGS. 3 and 4 one of the four wire-shaped welding filler materials 4 has been supplied such that its front end face has a greater distance from the respective other three end faces and from the optical axis of the laser beam 5, as a result of which less material or no material at all is melted off from this wire-shaped welding filler material 4 during the depositing welding.

By means of the electronic regulation and control unit 3 the feed of the four filler wires from the wire-shaped welding filler material 4 can be influenced such that the distances of the end faces of the filler wires can be adjusted as required and maintained during the coating process.

FIG. 5 shows how a different number of channels 17 can be provided at the welding nozzle 1 in order to convey a different number of wire-shaped welding filler materials 4 through the individual channels 17 from different directions into the region of influence of the laser beam 5. If necessary, powdered welding filler material can also be partly conveyed through the channels 17.

### LIST OF REFERENCE SIGNS

1 welding nozzle
2 wire feeder
3 electronic regulation and control unit
4 wire-shaped welding filler material
5 laser beam
6 deposition layer
7 workpiece
8 insulating element
9 strain gauge
10 contact arrangement
11 tensioning springs
12 current source for hot wire
13 electronic camera
14 camera coupling
15 reflective radiation
16 housing
17 channel

1.-5. (canceled)

6. A laser machining head with a housing and a welding nozzle, which are hollow on the inside and through which a laser beam is guided in the direction of a surface, wherein at least in the welding nozzle at least one channel, through which welding filler material is to be applied in the direction of the surface on the welding filler material via deposition welding, can be conveyed into the region of influence of the laser beam and can be melted by the energy of the laser beam and at least one of the following features i) to iv) is implemented at the laser machining head:
i) wire-shaped welding filler material is fed through the at least one channel by means of a wire feeder assigned to the wire-shaped welding filler material fed through a channel, which can be fed into the region of influence of the laser beam via a drive motor, and a device for determining the electric current flowing through the drive motor during the wire feed is provided on the respective drive motor for the wire feed, the measuring signals of which can be transmitted to an electronic regulating and control unit and the regulating and control unit is configured to influence the feed movement of the wire-shaped welding filler material with the measured electric current;
ii) at least one strain gauge is attached to an elastically deformable region of the housing or of the welding nozzle, which strain gauge is connected to the electronic regulation and control unit and the electronic regulation and control unit is configured to initiate a termination of the machining process when the measurement signal of the at least one strain gauge reaches a predeterminable measured signal threshold value;
iii) at least one contact arrangement is arranged and formed on the housing such that in the event of an impact or adhesion of the laser machining head to the respective surface of a workpiece or of a component to be manufactured additively or of other components, the electric contact is separated and a termination of the machining process is initiated by the electronic regulation and control unit on separation of the electric contact at the electric contact arrangement and/or
iv) an electronic camera is arranged and configured to record the region of the feed of welding filler material in the region of the nozzle opening of the welding nozzle and the electronic camera is connected to the electronic regulation and control unit and the electronic regulation and control unit is configured to influence the feed movement of at least one wire-shaped filler material or the volumetric flow of supplied powdered welding filler material on the basis of the recorded image in the region of the nozzle opening of the welding nozzle.

7. The laser machining head according to claim 6, wherein the laser machining head a camera coupling is provided which is configured to project an image of the region of the nozzle opening of the welding nozzle onto the electronic camera and image recognition software is integrated into the electronic regulation and control unit which software is designed to recognize wire-shaped or powdered welding filler material.

8. The laser machining head according to claim 6, wherein the beam path between the respective surface on which material is removed or welding filler material is conveyed into the region of influence of the laser beam and the electronic camera at least one optical filter is arranged by which it is possible to prevent electromagnetic radiation with at least the wavelength of the laser beam from impinging on the electronic camera.

9. The laser machining head according claim 6, wherein an electric current source is connected to a wire-shaped welding filler material for the electric resistance heating of the respective wire-shaped filler material and the temperature reached respectively at the wire-shaped welding filler material is determined by determining the electric resistance or the respective wire-shaped welding filler material or by a temperature sensor and a temperature regulation at the respective wire-shaped welding filler material can be carried out on the basis of the respectively determined temperature by the electronic regulation and control unit.

10. The laser machining head according to claim 6, wherein an optical filter is arranged in the beam path between the respective surface on which material is removed or welding filler material is conveyed into the region of influence of the laser beam and the electronic camera, by which it is possible to prevent electromagnetic radiation, which is emitted as a result of the melting process of the welding filler material by means of the laser radiation, from impinging on the electronic camera.
